(19) United States
(12) Patent Application Publication
(10) Pub. No.: US 2011/0246084 A1
(43) Pub. Date: Oct. 6, 2011

(54) METHODS AND SYSTEMS FOR ANALYSIS OF SEQUENCING DATA

(76) Inventors: Mostafa Ronaghi, San Diego, CA (US); Helmy A. Etoukhy, Woodside, CA (US)

(21) Appl. No.: 13/131,256

(22) PCT Filed: Nov. 24, 2009
(86) PCT No.: PCT/US09/65789

§ 371 Date: May 25, 2011

Related U.S. Application Data
(60) Provisional application No. 61/118,395, filed on Nov. 26, 2008.

(51) Int. Cl. G06F 19/10

(52) U.S. Cl. 702/20

(57) ABSTRACT

The present technology relates to the methods and systems for analysis of sequencing data. In particular, methods and systems for characterizing a target nucleic acid while determining the nucleotide sequence of the target nucleic acid are described. Certain embodiments include methods and systems for identifying the source of a target nucleic acid by comparing the accumulating nucleotide sequence of a target nucleic acid to a population of reference nucleotide sequences.

### CROSS-REFERENCE TO RELATED APPLICATIONS

This application is a nonprovisional application claiming priority to U.S. Provisional Application Ser. No. 61/118,395, filed Nov. 26, 2008, the disclosure of which is incorporated herein by reference in its entirety.

### FIELD OF THE INVENTION

The present technology relates to molecular sciences, such as genomics. More particularly, the present technology relates to methods and systems for the analysis of sequencing data.

### BACKGROUND

The detection of specific nucleic acid sequences present in a biological sample can be used as a method for identifying and classifying microorganisms, diagnosing infectious diseases, detecting and characterizing genetic abnormalities, identifying genetic changes associated with cancer, studying genetic susceptibility to disease, and measuring response to various types of treatment. A common technique for detecting specific nucleic acid sequences in a biological sample is nucleic acid sequencing.

Nucleic acid sequencing methodology has evolved significantly from the chemical degradation methods used by Maxam and Gilbert and the strand elongation methods used by Sanger. Today several sequencing methodologies are in use which allow for the parallel processing of thousands of nucleic acids all in a single sequencing run. As such, the information generated from a single sequencing run can be enormous.

### SUMMARY

The present technology relates to the analysis of sequencing data as it is being generated. In some embodiments of the present invention, such analysis permits the identification of the source of a target nucleic acid that is being sequenced prior to obtaining the complete sequence of the target nucleic acid or prior to the end of a sequencing run. In some embodiments, sequencing runs can be terminated prior to completion. In some of these and other embodiments, sequencing is terminated based on analyzing the data (e.g. the quantity of data, the quality of data, the information provided by the data—such as the ability of the information contained in the data to answer a question being asked, etc.). In some embodiments, sequencing is terminated based on analysis of the data which results in a determination that sufficient data has been obtained (e.g. sufficient data to identify a species, sufficient data to complete sequencing, sufficient data to identify all markers of interest, etc.). Sufficient data may include the minimum amount of data necessary to perform a certain analysis (e.g. identify a species, make a diagnosis, obtain a full sequence, etc.), or may include obtaining data with sufficient redundancy to add a desired confidence when performing the analysis. Terminating sequencing may include immediately terminating sequencing, performing a specified (e.g. fixed or variable) amount of further sequencing, and/or initiating a termination procedure (such as flushing reagents, sending a notice, etc.). In addition to, or as an alternative to terminating sequencing upon meeting the specified criteria, other actions could also be taken. When the specified data is obtained (e.g. the amount needed to identify a species, to make a diagnosis, etc.) a notice can be sent to a user (e.g. an electronic message can be sent, an indicator may illuminate or vibrate, etc.), a different system may be activated (e.g. to run another test, to take corrective action based on the diagnosis or species identified, etc.), and/or some other action may be taken in response to the determination that sufficient and/or specified data has been obtained.

In some embodiments of the present invention, methods and systems are described for characterizing a target nucleic acid while determining a portion of the nucleotide sequence of the target nucleic acid. Certain embodiments include methods and systems for identifying the source of a target nucleic acid by comparing the accumulating nucleotide sequence of a portion of a target nucleic acid, or the accumulating sequences of portions of a plurality of target nucleic acids, to a population of reference nucleotide sequences.

Some embodiments described herein include methods for identifying the source of a target nucleic acid. Such methods can include the steps of (a) initiating a sequencing process to determine the nucleotide sequence of a target nucleic acid or a fragment thereof, thereby generating a nucleotide sequence of at least a portion of the target nucleic acid; (b) prior to terminating the sequencing process, comparing the nucleotide sequence of the at least a portion of the target nucleic acid to a population of reference nucleotide sequences from specified organisms so as to identify a subpopulation of reference nucleotide sequences that match the nucleotide sequence of the at least a portion of the target nucleic acid at a specified threshold; and (c) determining whether the subpopulation of reference nucleotide sequences permit sufficient identification of the source of the target nucleic acid, wherein the sequencing process is continued and steps (b) and (c) are repeated if the subpopulation of reference nucleotide sequences does not permit sufficient identification of the source of the target nucleic acid, and wherein the sequencing process is terminated if the subpopulation of reference nucleotide sequences permits sufficient identification of the source of the target nucleic acid. In some embodiments, the sequencing process is terminated subsequent to the sufficient identification of the source of the target nucleic acid but prior to completely sequencing the target nucleic acid or prior to the completion of a sequencing run. In still other embodiments, the sequencing process can be terminated at the same time a sufficient identification of the source of the target nucleic acid is made.

In some embodiments the sequencing data may be collected to perform certain tests (e.g. to identify genetic diseases and/or markers in an individual). When sufficient information can be obtained from the data to perform the analysis, further sequencing can be terminated.

In some embodiments of the methods described herein, the sequencing process is an automated process.

In some embodiments of the methods described herein, the sequencing process can be performed on a single target nucleic acid. In other embodiments, the sequencing process can be performed simultaneously on a plurality of target nucleic acids. In such embodiments, the plurality of target nucleic acids can comprise target nucleic acids having different nucleotide sequences.

The methods described herein can also contemplate performing the sequencing process on a plurality of target nucleic acids on a surface of an array in parallel. In some such embodiments, the plurality of target nucleic acids can comprise target nucleic acids having different nucleotide sequences. In particular embodiments, the portion of the target nucleic acid that is sequenced includes a random sampling of regions in an organism's genome. Accordingly, the methods are particularly well suited to methods that are typically used for whole genome sequencing, providing the advantage of identifying the organism from which the genome was derived after only a fraction of the whole genome has been sequenced.

Aspects of the presently described methods are particularly relevant to the identification of target nucleic acids obtained from metagenomic samples. As such, in preferred embodiments, the methods described herein relate to the identification of the source of a target nucleic acid that is obtained from one or more metagenomic samples. In particular embodiments, the methods can be used to identify the source sufficiently to distinguish and/or identify the species (e.g. to uniquely identify the species, to uniquely identify a sub-species, to identify a set of species and/or subspecies, etc.) of organism from other candidate species. In some embodiments, identification of a set of species is sufficient (e.g. where each species and/or sub-species within the set is corrected or accounted for in a common way—such as treating using the same medicine, eradicated using the same technique, etc.) for the “identification of a species.” In other embodiments, identification of a species involves uniquely identifying the species.

In some embodiments of the methods described herein, the reference nucleotide sequences within the population of reference nucleotide sequences are indexed in a database by association with a particular species of the specified organism. In other embodiments, the reference nucleotide sequences are further indexed in the database by association with a particular subspecies of the specified organism. In still other methods for identifying the source of a target nucleic acid, the reference nucleotide sequences within the population of reference nucleotide sequences are indexed in a database by association with one or more groups of organisms. In some embodiments, the reference nucleotide sequences within the population of reference nucleotide sequences can be indexed in a database by a hierarchical association with a plurality of groups of organisms. In yet other embodiments, the plurality of groups of organisms can be phylogenetically related. In some embodiments of the methods described herein, the target nucleic acid contains at least a portion of a nucleic acid encoding one or more genes for which phylogenetic relationships are known. Such genes can be useful for identifying organisms of interest or relationships between organisms. Exemplary genes for which phylogenetic relationships are well established include, bit are not limited to, RuBisCo, NifH, sulfite reductase, a mitochondrial nucleic acid or 16S rRNA. In some embodiments, the mitochondrial nucleic acid comprises cytochrome c oxidase subunit I.

In some embodiments of the presently described methods, the sequencing process comprises array-based sequencing. In this and other embodiments, the sequencing process can comprise a process selected from the group consisting of sequencing by hybridization, sequencing by synthesis and sequencing by ligation. In additional embodiments, other methods of sequencing can be employed with the methods described herein.

Some of the methods described herein also include comparing the nucleotide sequence of at least a portion of a target nucleic acid to a population of reference nucleotide sequences using a heuristic algorithm. In such embodiments, the algorithm can comprise, for example, a BLAST algorithm or a FASTA algorithm.

In some of the methods described herein the threshold for determining whether a subpopulation of reference nucleotide sequences match the nucleotide sequence of the at least a portion of the target nucleic acid comprises a user specified threshold. In some embodiments, the threshold can be determined using one or more parameters. In some embodiments, the one or more parameters can comprise percent nucleotide sequence identity.

In some embodiments for identifying the source of a target nucleic acid, the subpopulation of reference nucleotide sequences permits sufficient identification of the source of the target nucleic acid if at least a specified percentage of the reference nucleotide sequences within the subpopulation are from the same genus of organism. In still other embodiments, the subpopulation of reference nucleotide sequences permits sufficient identification of the source of the target nucleic acid if at least a specified percentage of the reference nucleotide sequences within the subpopulation are from the same species of organism. In yet other embodiments, the subpopulation of reference nucleotide sequences permits sufficient identification of the source of the target nucleic acid if at least a specified percentage of the reference nucleotide sequences within the subpopulation are from the same subspecies of organism.

In addition to the methods described herein, systems for identifying the source of a target nucleic acid are described. Such systems can include: a computer containing a memory, the computer interfaced with a database containing a population of reference nucleotide sequences from specified organisms; a nucleic acid sequencer configured to perform a sequencing process to determine the nucleotide sequence of a target nucleic acid or a fragment thereof, thereby generating in said memory a nucleotide sequence of at least a portion of the target nucleic acid; a first program module interfaced with said computer, wherein the first program module is configured to compare the nucleotide sequence of the at least a portion of the target nucleic acid to the population of reference nucleotide sequences so as to identify a subpopulation of reference nucleotide sequences that match the nucleotide sequence of the at least a portion of the target nucleic acid at a specified threshold prior to the termination of said sequencing process; and a second program module interfaced with said computer, wherein the second program module is configured to determine whether the subpopulation of reference nucleotide sequences permits sufficient identification of the source of the target nucleic acid (e.g. species, sub-species, set of species and/or sub-species, etc.).

In some embodiments of the systems described herein, the second program module can be further configured to provide an instruction to continue the sequencing process if the subpopulation of reference nucleotide sequences does not permit sufficient identification of the source of the target nucleic acid. In still other embodiments, the second program module can be further configured to provide an instruction to terminate the sequencing process if the subpopulation of reference nucleotide sequences permits sufficient identification of the source of the target nucleic acid. In such embodiments, the instruction to terminate the sequencing process can be provided subsequent to the sufficient identification of the source of the target nucleic acid but prior to completely sequencing the target nucleic acid or prior to completing the sequencing run. In still other embodiments, the instruction to terminate the sequencing process can be provided at the same time a sufficient identification of the source of the target nucleic acid is made.

In some embodiments of the systems described herein, first and second program modules can be the same program module. In some embodiments, the first program module can be processed by the computer. In other embodiments, the first and second program modules can be both processed by the computer. In still other embodiments, the database can be a remote database. In yet other embodiments, the database can be a local database.

Some embodiments of the systems described herein contemplate the nucleic acid sequencer being under control of the computer. In other embodiments, the nucleic acid sequencer can be under independent control. In some embodiments, the nucleic acid sequencer can be located at the same site as the computer or located at a site remote from the computer. In some embodiments, the sequencing process can be an automated sequencing process. As discussed in connection with the methods set out above, in some embodiments, the sequencing process can be performed on a single target nucleic acid. In other embodiments, the sequencing process can be performed simultaneously on a plurality of target nucleic acids. In such embodiments, the plurality of target nucleic acids can comprise target nucleic acids having different nucleotide sequences.

The systems described herein can also contemplate nucleic acid sequencers that perform the sequencing process on a plurality of target nucleic acids on a surface of an array in parallel. In some such embodiments, the plurality of target nucleic acids can comprise target nucleic acids having different nucleotide sequences.

Some of the systems described herein are particularly useful for the identification of target nucleic acids obtained from metagenomic samples. As such, in preferred embodiments, the systems described herein relate to the identification of the source of a target nucleic acid that is obtained from one or more metagenomic samples.

In some embodiments of the systems described herein, the reference nucleotide sequences within the population of reference nucleotide sequences are indexed in the database by association with a particular species of the specified organism. In other embodiments, the reference nucleotide sequences are further indexed in the database by association with a particular subspecies of the specified organism. In still other systems for identifying the source of a target nucleic acid, the reference nucleotide sequences within the population of reference nucleotide sequences are indexed in the database by association with one or more groups of organisms. In some embodiments, the reference nucleotide sequences within the population of reference nucleotide sequences can be indexed in the database by a hierarchical association with a plurality of groups of organisms. In yet other embodiments, the plurality of groups of organisms can be phylogenetically related. In some embodiments of the methods described herein, the target nucleic acid contains at least a portion of a nucleic acid encoding RuBisCo, NifH, sulfite reductase, a mitochondrial nucleic acid or 16S rRNA. In some embodiments, the mitochondrial nucleic acid comprises cytochrome c oxidase subunit I.

In some embodiments of the presently described systems, the sequencing process comprises array-based sequencing. In this and other embodiments, the sequencing process can comprise a process selected from the group consisting of sequencing by hybridization, sequencing by synthesis and sequencing by ligation. In additional embodiments, other methods of sequencing can be employed with the systems described herein.

Some of the systems described herein utilize one or more heuristic algorithms to compare the nucleotide sequence of the at least a portion of the target nucleic acid to the population of reference nucleotide sequences. In such embodiments, the algorithm can comprise, for example, a BLAST algorithm or a FASTA algorithm.

In some of the systems described herein the threshold for determining whether a subpopulation of reference nucleotide sequences match the nucleotide sequence of the at least a portion of the target nucleic acid can comprise a user specified threshold. In some embodiments, the threshold can be determined using one or more parameters. In some embodiments, the one or more parameters can comprise percent nucleotide sequence identity.

In some embodiments of the systems for identifying the source of a target nucleic acid, the subpopulation of reference nucleotide sequences permits sufficient identification of the source of the target nucleic acid if at least a specified percentage of the reference nucleotide sequences within the subpopulation are from the same genus of organism. In still other embodiments, the subpopulation of reference nucleotide sequences permits sufficient identification of the source of the target nucleic acid if at least a specified percentage of the reference nucleotide sequences within the subpopulation are from the same species of organism. In yet other embodiments, the subpopulation of reference nucleotide sequences permits sufficient identification of the source of the target nucleic acid if at least a specified percentage of the reference nucleotide sequences within the subpopulation are from the same subspecies of organism.

### BRIEF DESCRIPTION OF THE DRAWINGS

FIG. 1 shows a schematic diagram for a system to identify the source of a target nucleic acid.

### DETAILED DESCRIPTION

The invention arises, at least in part, from the recognition that although large amounts of sequencing data can be rapidly generated in a single sequencing run, certain goals can be achieved by using only a portion of the sequencing data that is generated. For example, methods and systems can be used for identifying the source of a target nucleic acid by using only partial sequencing data obtained from a partial sequencing run. The invention arises, at least in part, from the recognition that if methods and/or systems could be developed to utilize partial sequencing data in a beneficial way, such as identifying the source of a target nucleic acid prior to completing the sequencing of the target nucleic acid or prior to completing an entire sequencing run, such methods and/or systems would result in the conservation of sequencing reagents, the savings of time and/or the reduction of sequencing costs. Additionally, the invention arises, at least in part, from the recognition that that such methods and systems would provide a mechanism by which to make identifications of the source of a target nucleic acid in a rapid manner for applications where time is of the essence.

Specific applications of the methods and systems described herein include the rapid analysis of sequence data, including but not limited to, the identification of the source of one or more target nucleic acids. Such applications can be useful for identifying pathogens at the point of patient care, for example, in emergency diagnostic tests. Such identification of pathogens can direct the use of efficacious drugs to treat the identified pathogens. Other applications include the evaluation of when sufficient data is available for a sequencing run to be terminated, thus resulting in the conservation of reagents, the savings of time and/or the savings of costs.

Aspects of the methods and systems described herein relate to the utilization of partial sequencing data to identify the source of a target nucleic acid prior to completely sequencing the target nucleic acid or prior to completing a sequencing run. As used herein, “a sequencing run” or grammatical variants thereof refers to a repetitive process of physical or chemical steps that is initiated on a nucleic acid target and carried out to obtain signals indicative of the order of bases in the target. The process can be carried out to its typical completion, which is usually defined by the point at which signals from the process can no longer distinguish bases of the target with a reasonable level of certainty. A sequencing run can be carried out on a single target nucleic acid molecule or simultaneously on a population of target nucleic acid molecules having the same sequence, or simultaneously on a population of target nucleic acids having different sequences. In some embodiments, a sequencing run is terminated when signals are no longer obtained from one or more target nucleic acid molecules from which signal acquisition was initiated. For example, a sequencing run can be initiated for one or more target nucleic acid molecules that are present on a solid phase substrate and terminated upon removal of the one or more target nucleic acid molecules from the substrate or otherwise ceasing detection of the target nucleic acids that were present on the substrate when the sequencing run was initiated.

As used herein, “sequence calling,” “base calling” and grammatical equivalents thereof refer to determining the order of bases in a nucleic acid based on data obtained from a sequencing run. A process of sequence calling can be initiated prior to the completion of the sequencing run from which the data is obtained.

As used herein, “sequencing process” and grammatical equivalents thereof refers to the combined act performing a sequencing run and sequence calling.

In some embodiments, methods and systems are described for identifying the source of, or otherwise characterizing, a target nucleic acid while performing a sequencing run or determining the nucleotide sequence of a portion of the target nucleic acid or a fragment thereof. Some embodiments include methods and systems for identifying the source of a target nucleic acid by comparing the accumulating nucleotide sequence of a portion of a target nucleic acid or fragment thereof to a population of reference nucleotide sequences. As used herein, “accumulating nucleotide sequence” and grammatical equivalents thereof refers to nucleotide sequence that has been generated from a sequencing run prior to the completion of the sequencing run. In some embodiments, the sequencing run may continue to accumulate signals while previously accumulated sequence is analyzed. In other embodiments, the sequencing run may be paused during the analysis of accumulated sequence. In each of the above embodiments, the identification of the source of the target nucleic acid can be made prior to completely sequencing the target nucleic acid or prior to completing the sequencing run.

Methods for identifying the source of a target nucleic acid are described herein. Such methods can include the steps of (a) initiating a sequencing process to determine the nucleotide sequence of a target nucleic acid or a fragment thereof, thereby generating a nucleotide sequence of at least a portion of the target nucleic acid; (b) prior to terminating the sequencing process, comparing the nucleotide sequence of the at least a portion of the target nucleic acid to a population of reference nucleotide sequences from specified organisms so as to identify a subpopulation of reference nucleotide sequences that match the nucleotide sequence of the at least a portion of the target nucleic acid at a specified threshold; and (c) determining whether the subpopulation of reference nucleotide sequences permit sufficient identification of the source of the target nucleic acid, wherein the sequencing process is continued and steps (b) and (c) are repeated if the subpopulation of reference nucleotide sequences does not permit sufficient identification of the source of the target nucleic acid, and wherein the sequencing process is terminated if the subpopulation of reference nucleotide sequences permits sufficient identification of the source of the target nucleic acid.

It will be appreciated that termination of the sequencing process can occur subsequent to the sufficient identification of the source of the target nucleic acid but prior to completely sequencing the target nucleic acid or prior to the completion of a sequencing run. Alternatively, in preferred methods, the sequencing process can be terminated at the same time a sufficient identification of the source of the target nucleic acid is made.

In addition to methods described herein, systems for identifying the source of a target nucleic acid are provided. Such systems can include: a computer containing a memory, the computer interfaced with a database containing a population of reference nucleotide sequences from specified organisms; a nucleic acid sequencer configured to perform a sequencing process to determine the nucleotide sequence of a target nucleic acid or a fragment thereof, thereby generating in said memory a nucleotide sequence of at least a portion of the target nucleic acid; a first program module interfaced with said computer, wherein the first program module is configured to compare the nucleotide sequence of the at least a portion of the target nucleic acid to the population of reference nucleotide sequences so as to identify a subpopulation of reference nucleotide sequences that match the nucleotide sequence of the at least a portion of the target nucleic acid at a specified threshold prior to the termination of said sequencing process; and a second program module interfaced with said computer, wherein the second program module is configured to determine whether the subpopulation of reference nucleotide sequences permits sufficient identification of the source of the target nucleic acid.

One or both of the program modules in the systems described herein can be further configured to provide an instruction to continue the sequencing process if the subpopulation of reference nucleotide sequences does not permit sufficient identification of the source of the target nucleic acid. Furthermore, one or both of these modules can be further configured to provide an instruction to terminate the sequencing process if the subpopulation of reference nucleotide sequences permits sufficient identification of the source of the target nucleic acid. The instruction to terminate the sequencing process can be provided subsequent to the sufficient identification of the source of the target nucleic acid but prior to completely sequencing the target nucleic acid or prior to completing the sequencing run. Alternatively, the instruction to terminate the sequencing process can be provided at the same time a sufficient identification of the source of the target nucleic acid is made.

It will be appreciated that the functions provided by the first and second program modules can be divided or combined in various ways as long as the functionality of the modules is retained. For example, all of the functions of the first and second program module could be implemented in a single program module. Alternately, the functions of these modules can be divided among three or more program modules.

Target Nucleic Acids

In the methods and systems described herein, a target nucleic acid can include any nucleic acid of interest. Target nucleic acids can include DNA, RNA, peptide nucleic acid, morpholino nucleic acid, locked nucleic acid, glycol nucleic acid, threose nucleic acid, mixtures thereof, and hybrids thereof. In preferred embodiments, the target nucleic acid is obtained from one or more source organisms. As used herein the term “organism” means any living or self replicating particle that is or was previously in existence. As used herein the term “organism” is not necessarily limited to a particular species of organism but can be used to refer to the living or self replicating particle at any level of classification. For example, the term “organism” can be used to refer collectively to all of the species within the genus Salmonella or all of the bacteria within the kingdom Eubacteria.

A target nucleic acid can comprise any nucleotide sequence. In some embodiments, the nucleotide sequence comprises a full-length coding sequence for one or more proteins. In other embodiments, the nucleotide sequence comprises at least a portion of a coding sequence for one or more proteins. In still other embodiments, the nucleotide sequence comprises at least a portion of a noncoding sequence.

As used in connection with a nucleic acid, “at least a portion” means a consecutive sequence of at least 5 nucleotides, at least 10 nucleotides, at least 15 nucleotides, at least 20 nucleotides, at least 25 nucleotides, at least 30 nucleotides, at least 35 nucleotides, at least 40 nucleotides, at least 45 nucleotides, at least 50 nucleotides, at least 60 nucleotides, at least 70 nucleotides, at least 80 nucleotides, at least 90 nucleotides, at least 100 nucleotides, at least 125 nucleotides, at least 150 nucleotides, at least 175 nucleotides, at least 200 nucleotides, at least 250 nucleotides, at least 300 nucleotides, at least 350 nucleotides, at least 400 nucleotides, at least 450 nucleotides, at least 500 nucleotides or greater than 500 nucleotides. In preferred embodiments, at least a portion means a consecutive sequence of between at least about 20 nucleotides to at least about 250 nucleotides.

Exemplary target nucleic acid can include nucleic acids comprising one or more nucleotide sequences that include at least a portion of a nucleotide sequence present in mitochondrial or chloroplast DNA. In certain embodiments, the a least a portion of the nucleotide sequence present in mitochondrial or chloroplast DNA is unique to mitochondrial or chloroplast DNA. Other target nucleic acids can include at least a portion of an rRNA sequence. Still other target nucleic acids can include at least a portion of a nucleotide sequence present in a virus or other nucleic-acid-containing particle or element.

In some embodiments, the target nucleic acid can comprise a selected sequence. For example, such sequences can include sequences encoding at least a portion of RuBisCo, NifH, sulfite reductase, a mitochondrial nucleic acid or 16S rRNA. In some embodiments, the mitochondrial nucleic acid comprises cytochrome c oxidase subunit I. In some embodiments, sequencing a portion of a target nucleic acid or a fragment thereof can be used to identify the source of the target nucleic acid. In other embodiments, particular genes or regions of a genome need not be sequenced including, for example, sequences encoding at least a portion of RuBisCo, NifH, sulfite reductase, a mitochondrial nucleic acid such as cytochrome c oxidase subunit I, or 16S rRNA.

Some embodiments can utilize a single target nucleic acid. Other embodiments can utilize a plurality of target nucleic acids. In such embodiments, a plurality of target nucleic acids can include a plurality of the same target nucleic acids, a plurality of different target nucleic acids where some target nucleic acids are the same, or a plurality of target nucleic acids where all target nucleic acids are different. In some embodiments, the plurality of target nucleic acids can include substantially all of a particular organism's genome. The plurality of target nucleic acids can include at least a portion of a particular organism's genome including, for example, at least about 10%, 15%, 20%, 25%, 30%, 35%, 40%, 45%, 50%, 55%, 60%, 65%, 70%, 75%, 80%, 85%, 90%, 95%, or 99% of the genome.

Target nucleic acids can be obtained from any source. For example, target nucleic acids may be prepared from nucleic acid molecules obtained from a single organism or from populations of nucleic acid molecules obtained from natural sources that include one or more organisms. Sources of nucleic acid molecules include, but are not limited to, organelles, cells, tissues, organs, or organisms. Cells that may be used as sources of target nucleic acid molecules may be prokaryotic (bacterial cells, e.g., Escherichia, Bacillus, Serratia, Salmonella, Staphylococcus, Streptococcus, Clostridium, Chlamydia, Neisseria, Treponema, Mycoplasma, Borrelia, Legionella, Pseudomonas, Mycobacterium, Helicobacter, Erwinia, Agrobacterium, Rhizobium, and Streptomyces genera); archeaon, such as crenarchaeota, nanoarchaeota or euryarchaeotia; or eukaryotic such as fungi, (e.g., yeasts), plants, protozoans and other parasites, and animals (including insects (e.g., Drosophila spp.), nematodes (e.g., Caenorhabditis elegans), and mammals (e.g., rat, mouse, monkey, non-human primate and human)).

In some embodiments, a target nucleic acid can be obtained from a specific biological source. In a preferred embodiment, the target nucleic acid is human nucleic acid obtained from a human, for example a sample of human tissue. In an especially preferred embodiment, the target nucleic acid is a human mitochondrial nucleic acid. In another preferred embodiments, the nucleic acid can be obtained from a metagenomic sample. In other embodiments, the target nucleic acid can be obtained from an environmental source that no longer comprises living organisms.

Sequence Profiles

Certain embodiments of the methods and systems described herein have particular value even in cases where a plurality of target nucleic acids are obtained from a sample comprising a plurality of organisms. In some embodiments, such samples are metagenomic samples or uncultured samples. Metagenomic samples can be obtained from nearly any area in the environment. For example, metagenomic samples can be obtained from places as diverse as the ocean, a landfill, foodstuffs, the skin or gut of an animal, such as a human, or a surface in a hospital. Because target nucleic acids in a metagenomic sample can be sequenced or partially sequenced, a sequence profile for the sample can be established. The sequence profile for any a particular metagenomic sample can be compared to a sequence profile for one or more samples that are obtained from like or similar environments or alternatively the sequence profile for samples taken from the same environment or location at different points in time can be compared.

In the case of comparison of sequence profiles obtained from different environments, differences in sequence profiles can be correlated with certain events or conditions occurring at the different environment. For example, children in developing countries are commonly exposed to poor sanitary conditions resulting in the spread of viruses and bacteria that cause severe diarrhea. Typically the flora present in samples obtained from the guts of children can contain different compositions of microorganisms. Severe diarrhea is associated with imbalances in the flora of the gut. If a sequence profile of gut microbes is obtained from children in a population of healthy children, the profiles will share a certain level of similarity. If a sequence profile of gut microbes is obtained from children in a population suffering from diarrhea, the sequence profiles will often be different from those obtained from the healthy children. Furthermore, several different profiles may be obtained from the population of children suffering from diarrhea. For example, a plurality of different sequence profiles may be obtained from the population of children suffering from diarrhea, some of which are similar to each other, but none of which are similar to sequence profiles obtained from healthy children. Moreover, children having different profiles may be responsive to different treatment regimens. For example, children with profile type A may be responsive to regimen A, children with profile type B may be responsive to regimen B and so forth. In this way, both a condition and a treatment for the condition can be correlated with a particular sequence profile. As demonstrated by the above example, the methods set forth herein are useful for diagnosing any of a variety of conditions or diseases whether genetically based or based on the presence of particular pathogens or both.

In the case of comparison of sequence profiles obtained from the same environment or location over time, difference in sequence profiles can be used to detect events that have occurred in the environment or at the location. For example, samples can be obtained from a hospital surface at various time points to determine whether a change in the composition of flora has occurred. In the event that a change has occurred, the location may be identified as a potential contact point harboring one or more pathogenic organisms.

In some embodiments of the methods and systems described herein, sequence profiles can be identified prior to completely sequencing the target nucleic acids in the metagenomic samples or prior to completing a sequencing run. This permits rapid identification of sequence profiles for diagnostic purposes, which is particularly useful for time critical applications.

Sequence Determination

In some methods and systems described herein, the nucleotide sequence of a portion of a target nucleic acid or fragment thereof can be determined using a variety of methods and devices. Examples of sequencing methods include electrophoretic, sequencing by synthesis, sequencing by ligation, sequencing by hybridization, single-molecule sequencing, and real time sequencing methods. In some embodiments, the process to determine the nucleotide sequence of a target nucleic acid can be an automated process.

Electrophoretic sequencing methods include Sanger sequencing protocols and conventional electrophoretic techniques (Sanger, F., Nicklen, S. and Coulson, A. R. (1977) DNA sequencing with chain-terminating inhibitors. Proc. Natl. Acad. Sci. USA. 74(12), 5463-7; Swerdlow, H., Wu, S. L., Harke, H. & Dovichi, N. J. Capillary gel electrophoresis for DNA sequencing. Laser-induced fluorescence detection with the sheath flow cuvette. J. Chromatogr. 516, 61-67 (1990); Hunkapiller, T., Kaiser, R. J., Koop, B. F. & Hood, L. Large-scale and automated DNA sequence determination. Science 254, 59-67 (1991)). In such embodiments, electrophoresis can be carried out on a microfabricated device (Paegel, B. M., Blazej, R. G. & Mathies, R. A. Microfluidic devices for DNA sequencing: sample preparation and electrophoretic analysis. Curr. Opin. Biotechnol. 14, 42-50 (2003); Hong, J. W. & Quake, S. R. Integrated nanoliter systems. Nat. Biotechnol. 21, 1179-1183 (2003), the disclosures of which are incorporated herein by reference in their entireties).

Preferred embodiments include sequencing by synthesis (SBS) techniques. SBS techniques generally involve the enzymatic extension of a nascent nucleic acid strand through the iterative addition of nucleotides against a template strand. Each nucleotide addition queries one or a few bases of the template strand. In one exemplary type of SBS, cycle sequencing is accomplished by stepwise addition of reversible terminator nucleotides containing, for example, a cleavable or photobleachable dye label. This approach is being commercialized by Solexa (now Illumina), and is also described in WO 91/06678, which is incorporated herein by reference in its entirety. The availability of fluorescently-labeled terminators in which both the termination can be reversed and the fluorescent label cleaved is important to facilitating efficient cyclic reversible termination (CRT) sequencing. Polymerases can also be co-engineered to efficiently incorporate and extend from these modified nucleotides. In particular embodiments, reversible terminators/cleavable fluors can include fluor linked to the ribose moiety via a 3′ ester linkage (Metzker, Genome Res. 15:1767-1776 (2005), which is incorporated herein by reference). Other approaches have separated the terminator chemistry from the cleavage of the fluorescence label (Ruparel et al., Proc Natl Acad Sci U S A 102: 5932-7 (2005), which is incorporated herein by reference in its entirety). Ruparel et al described the development of reversible terminators that used a small 3′ allyl group to block extension, but could easily be deblocked by a short treatment with a palladium catalyst. The fluorophore was attached to the base via a photocleavable linker that could easily be cleaved by a 30 second exposure to long wavelength UV light. Thus, both disulfide reduction or photocleavage can be used as a cleavable linker. Another approach to reversible termination is the use of natural termination that ensues after placement of a bulky dye on a dNTP. The presence of a charged bulky dye on the dNTP can act as an effective terminator through steric and/or electrostatic hindrance. The presence of one incorporation event prevents further incorporations unless the dye is removed. Cleavage of the dye removes the fluor and effectively reverses the termination. Examples of modified nucleotides are also described in U.S. Pat. No. 7,427,673, and U.S. Pat. No. 7,057,026, the disclosures of which are incorporated herein by reference in their entireties.

Other SBS techniques to detect the addition of nucleotides into a nascent strand include pyrosequencing techniques. Pyrosequencing detects the release of inorganic pyrophosphate (PPi) as particular nucleotides are incorporated into the nascent strand (Ronaghi, M., Karamohamed, S., Pettersson, B., Uhlen, M. and Nyren, P. (1996) Real-time DNA sequencing using detection of pyrophosphate release. Analytical Biochemistry 242(1), 84-9; Ronaghi, M. (2001) Pyrosequencing sheds light on DNA sequencing. Genome Res 11(1), 3-11; Ronaghi, M., Uhlen, M. and Nyren, P. (1998) A sequencing method based on real-time pyrophosphate. Science 281(5375), 363), the disclosures of which are incorporated herein by reference in their entireties). In pyrosequencing, released PPi can be detected by being immediately converted to adenosine triphosphate (ATP) by ATP sulfurylase, and the level of ATP generated is detected via luciferase-produced photons.

Additional exemplary SBS systems and methods which can be utilized with the methods and systems described herein are described in U.S. Patent Application Publication No. 2007/0166705, U.S. Patent Application Publication No. 2006/0188901, U.S. Pat. No. 7,057,026, U.S. Patent Application Publication No. 2006/0240439, U.S. Patent Application Publication No. 2006/0281109, PCT Publication No. WO 05/065814, US Patent Application Publication No. 2005/0100900, PCT Publication No. WO 06/064199 and PCT Publication No. WO 07/010251, the disclosures of which are incorporated herein by reference in their entireties.

Some embodiments can utilize sequencing by ligation techniques. Such techniques utilize DNA ligase to incorporate nucleotides and identify the incorporation of such nucleotides. Exemplary systems and methods which can be utilized with the methods and systems described herein are described in U.S. Pat. No 6,969,488, U.S. Pat. No. 6,172,218, and U.S. Pat. No. 6,306,597, the disclosures of which are incorporated herein by reference in their entireties. Sequencing by ligation can involve separate sets of ligation where each set is initiated using a primer that is offset from one or more primers for other sets, may involve using probes where labels represent identities of bases that are off-set from the bases of other sets, may include cleaving most or a portion of the a probe, may use an exonuclease, and/or may use some other technique (including a combination of these techniques).

Some embodiments include methods utilizing sequencing by hybridization techniques. In such embodiments, differential hybridization of oligonucleotide probes can be used to decode a target DNA sequence (Bains, W. and Smith, G. C. A novel method for nucleic acid sequence determination. Journal of Theoretical Biology 135(3), 303-7 (1988); Drmanac, S. et al., Accurate sequencing by hybridization for DNA diagnostics and individual genomics. Nature Biotechnology 16, 54-58 (1998); Fodor, S. P. A., Read, J. L., Pirrung, M. C., Stryer, L., Lu, A. T. and Solas, D. Light-directed, spatially addressable parallel chemical synthesis. Science 251(4995), 767-773(1995); Southern, E. M. (1989) Analyzing polynucleotide sequences. WO 1989/10977), the disclosures of which are incorporated herein by reference in their entireties). The target DNA can be immobilized on a solid support and serial hybridizations can be performed with short probe oligonucleotides, for example, oligonucleotides 5 to 8 nucleotides in length. The extent to which specific probes bind to the target DNA can be used to infer the unknown sequence. Target DNA can also be hybridized to high density oligonucleotide arrays (Lipshutz, R. J. et al., (1995) Using oligonucleotide probe arrays to access genetic diversity. Biotechniques 19, 442-447, the disclosure of which is incorporated herein by reference in its entirety).

Some embodiments can utilize nanopore sequencing (Deamer, D. W. & Akeson, M. “Nanopores and nucleic acids: prospects for ultrarapid sequencing.” Trends Biotechnol. 18, 147-151 (2000); Deamer and Branton, 2002 “Characterization of nucleic acids by nanopore analysis.” Acc Chem Res. 2002 35:817-25; and Li et al., “DNA molecules and configurations in a solid-state nanopore microscope.” Nat Mater. 2(9):611-5 (2003), the disclosures of which are incorporated herein by reference in their entireties). Nanopore sequencing is one method of rapidly determining the sequence of nucleic acid molecules. Nanopore sequencing is based on the property of physically sensing the individual nucleotides (or physical changes in the environment of the nucleotides, such as electric current) within an individual polynucleotide as it traverses through a nanopore aperture. In principle, the sequence of a polynucleotide can be determined from a single molecule. However, a polynucleotide sequence be determined from a statistical average of data obtained from multiple passages of the same molecule or the passage of multiple molecules having the same polynucleotide sequence. The use of membrane channels to characterize polynucleotides as the molecules pass through the small ion channels has been studied by Kasianowicz et al. (Proc. Natl. Acad. Sci. USA. 93:13770 3, 1996, incorporated by reference in its entirety) by using an electric field to force single stranded RNA and DNA molecules through a 2.6 nm diameter nanopore aperture, namely, an ion channel, in a lipid bilayer membrane.

Accordingly, in some such embodiments, the target nucleic acid passes through a nanopore. The nanopore can be a synthetic pore or biological membrane protein, such as a-hemolysin, gramicidin A, maltoporin, OmpF, OmpC, PhoE, Tsx, F-pilus, mitochondrial porin (VDAC) (U.S. Pat. No. 6,015,714, incorporated by reference in its entirety).. In some embodiments, as the target nucleic acid passes through the nanopore, each base-pair can be identified by measuring fluctuations in the electrical conductance of the pore. (U.S. Pat. No. 7,001,792; U.S. Pat. No. 6,267,872; Soni, G. V. & Meller, A. Progress toward ultrafast DNA sequencing using solid-state nanopores. Clin. Chem. 53, 1996-2001 (2007); Healy, K. Nanopore-based single-molecule DNA analysis. Nanomed. 2, 459-481 (2007); and Cockroft, S. L., Chu, J., Amorin, M. & Ghadiri, M. R. A single-molecule nanopore device detects DNA polymerase activity with single-nucleotide resolution. J. Am. Chem. Soc. 130, 818-820 (2008), the disclosures of which are incorporated herein by reference in their entireties).

Examples of devices that may used for nanopore sequencing of polymers, including nucleic acids, are described in U.S. Pat. No. 7,238,485, and 7,189,503, which are incorporated by reference in their entireties. In some such embodiments, devices and/or methods for nanopore sequencing can include one or more of the following components: a nanopore aperture, a molecular motor disposed adjacent the aperture, where the molecular motor is capable of moving a polymer with respect to the aperture. In some embodiments, methods are employed to control the rate of movement of the polymer. By making measurements as the polymer is moved, the polymer may be characterized. Any molecular motor that is capable of moving a polynucleotide of interest may be utilized. Molecular motors can, but are not required to, include one or more desirable properties as follows: (1) sequential action, such as, addition or removal of one nucleotide per turnover; (2) no backtracking along the target polynucleotide; (3) no slippage of the motor on the target polynucleotide due to forces, such as, from an electric field, employed to drive a polynucleotide to the motor; (4) retention of catalytic function when disposed adjacent a nanopore aperture; and (5) high processivity, such as, the ability to remain bound to target polynucleotide and perform at least 1,000 rounds of catalysis before dissociating. Examples of useful molecular motors include, polymerases such as DNA polymerase and RNA polymerase, helicases, ribosomes, and exonucleases. In some embodiments, one or more molecular motors may be located at one or more of before the pore, after the pore, and in the pore. In one embodiment, an exonuclease is fused with an alpha-hemolysin (or other organic or a solid-state) pore such that the exonuclease cleaves a nucleic acid base-by-base such that dissociated bases travel through the pore and are introduced at a rate equal to the processivity of the exonuclease. In other embodiments the polymer passes through the pore in tact rather than in the form of dissociated bases (e.g. using an exonuclease at the back of the pore, by using a polymerase, etc.).

Some embodiments can utilize methods involving the real-time monitoring of DNA polymerase activity. In some embodiments, nucleotide incorporations can be detected through fluorescence resonance energy transfer (FRET) interactions between a fluorophore-bearing polymerase and γ-phosphate-labeled nucleotides, or with zeromode waveguides. The illumination can be restricted to a zeptoliter-scale volume around a surface-tethered polymerase such that incorporation of fluorescently labeled nucleotides can be observed with low background (Levene, M. J. et al. Zero-mode waveguides for single-molecule analysis at high concentrations. Science 299, 682-686 (2003); Lundquist, P. M. et al. Parallel confocal detection of single molecules in real time. Opt. Lett. 33, 1026-1028 (2008); Korlach, J. et al. Selective aluminum passivation for targeted immobilization of single DNA polymerase molecules in zero-mode waveguide nanostructures. Proc. Natl. Acad. Sci. USA 105, 1176-1181 (2008); and Foquet, M. et al., “Improved fabrication of zero-mode waveguides for single-molecule detection, J. Appl. Phys. 103, 03401 (2008), the disclosures of which are incorporated herein by reference in their entireties).

In more embodiments that utilize real-time monitoring of DNA polymerase activity, DNA sequencing can be performed using arrays of zero-mode waveguides (ZMW.s). An example ZMW includes a chamber, hole, well or depression on a substrate with a volume, for example, of less than about 20 zeptoliters (10⁻²¹ liters). A substrate can comprise a plurality of ZMW.s. An example substrate includes a 100 nm metal film deposited on a silicon dioxide substrate. In such example, each ZMW can provide a nanophotonic visualization chamber providing a detection volume such that the activity of a single molecule can be detected. Due to the small size of the ZMW, diffusion to and from the ZMW of nucleotides is rapid, thus low background levels can be achieved. As a DNA polymerase incorporates complementary nucleotides, each base can be held within the detection volume for tens of milliseconds, orders of magnitude longer than the amount of time it takes a nucleotide to diffuse in and out of the detection volume. During this time, a nucleotide labeled with a fluorophore emits fluorescent light that may correspond to a particular base, such as ‘A’, ‘C’, ‘T’, or ‘G’. The polymerase may then cleave the bond holding the fluorophore in place and the dye diffuses out of the detection volume. Following incorporation, the signal immediately returns to baseline and the process repeats. The DNA polymerase may continue to incorporate bases. An example polymerase that may be used includes φ29 DNA polymerase. In some examples, fluorescently labeled deoxyribonucleoside triphosphates may be utilized (Eid et al., “Real-Time DNA Sequencing from Single Polymerase Molecules” Science 323:133-138 (2009), incorporated by reference in its entirety). In another example, labeled-nucleotides include deoxyribonucleotide pentaphosphates such as those described in Korlach, J. et al., “Long, processive enzymatic DNA synthesis using 100% dye-labeled terminal phosphate-linked nucleotides.” Nucleosides, Nucleotides and Nucleic Acids, 27:1072-1083 (2008), incorporated by reference in its entirety. More examples of ZMW.s, methods, and nucleotides that may be utilized with the methods provided herein can be found in U.S. Pat. No. 7,563,574, U.S. Pat. No. 7,485,424, U.S. Pat. No. 7,292,742, U.S. Pat. No. 7,056,676, which are incorporated by reference in their entireties.

Some embodiments described herein contemplate real-time monitoring of DNA polymerase activity using a ZMW comprising a substrate layer, a cladding layer disposed upon the substrate layer, and a core including a hole disposed through the cladding layer, in which the hole is configured to substantially preclude electromagnetic energy of a frequency less than a cutoff frequency entering the core from propagating longitudinally through said zero mode waveguide. More embodiments that can utilize real-time monitoring of DNA polymerase activity, can include methods for sequencing a target nucleic acid molecule that can include one or more of the following steps: (a) subjecting a target nucleic acid molecule to a polymerization reaction to yield a growing nucleic acid strand that is complementary to the target nucleic acid molecule in the presence of a plurality of types of nucleotides or nucleotide analogs, in which the target nucleic acid molecule and/or the nucleic acid polymerization enzyme is attached to a support; and (b) identifying a time sequence of incorporation of the plurality of types of nucleotides or nucleotide analogs into the growing nucleotide strand at an active site complementary to the target nucleic acid under conditions to identify a plurality of incorporated nucleotides or nucleotide analogs per second during said polymerization reaction. In some embodiments, the identification of a time sequence of incorporation of the plurality of type of nucleotides or nucleotide analogs includes optically identification.

In some embodiments, the nucleic acids being monitored and/or sequenced may be in the form of single molecules (which may be a natural molecule, a modified molecule such as a labeled molecule or nucleic acid including nucleotide analogs), a concatamer of a sequence, etc.), may be amplified (e.g. amplified into a concatamer, amplified into multiple individual molecules of the same or similar sequence, etc.), and/or may be in any other form.

It will be appreciated that any of the above-described sequencing processes can be incorporated into the methods and/or systems described herein. Furthermore, it will be appreciated that other known sequencing processes can be easily by implemented for use with the methods and/or systems described herein.

Identification of the Source of the Target Nucleic Acid

In some methods and systems described herein, the accumulating nucleotide sequence data of a target nucleic acid or fragment thereof can be analyzed as the sequence is determined. In preferred embodiments, the source of a target nucleic acid can be identified by analyzing the accumulating nucleotide sequence data of the target nucleic acid. In such embodiments, the analysis can include comparing the accumulating nucleotide sequence data of a portion of the target nucleic acid with a population of reference nucleotide sequences, identifying (or otherwise creating or establishing) a subpopulation of a reference nucleotide sequences, and determining whether the subpopulation permits sufficient identification of the source of the target nucleic acid.

It will be appreciated that a portion of the target nucleic acid also includes a portion of a fragment of a target nucleic acid in the event that only a fragment of the target nucleic acid is selected for analysis.

The accumulating nucleotide sequence data can correspond to at least a portion of the nucleotide sequence of the target nucleic acid. In some embodiments, the at least a portion of the nucleotide sequence can have a length of at least 5 nucleotides, at least 10 nucleotides, at least 20 nucleotides, at least 30 nucleotides, at least 40 nucleotides, at least 50 nucleotides, at least 60 nucleotides, at least 70 nucleotides, at least 80 nucleotides, at least 90 nucleotides, at least 100 nucleotides, at least 110 nucleotides, at least 120 nucleotides, at least 130 nucleotides, at least 140 nucleotides, at least 150 nucleotides, at least 200 nucleotides, and at least 500 nucleotides. Alternatively, in some embodiments, the at least a portion of the nucleotide sequence can have a length of at least 5 nucleotides to about 200 nucleotides, at least 10 nucleotides to about 150 nucleotides, at least 20 nucleotides to about 150, at least 20 nucleotides to about 100 nucleotides, at least 20 nucleotides to about 50 nucleotide, at least 30 nucleotides to about 100 nucleotides or at least 30 nucleotides to about 50 nucleotides. In some embodiments, the accumulating nucleotide sequence data may or may not contain ambiguous nucleotide calls as the sequence is determined. In some embodiments, at least a portion of the accumulating sequence data may be analyzed. In some embodiments, at least about 10%, 15%, 20%, 25%, 30%, 35%, 40%, 45%, 50%, 55%, 60%, 65%, 70%, 75%, 80%, 85%, 90%, 95%, or 99% of the accumulating sequence data may be analyzed.

In some embodiments, the at least a portion of the nucleotide sequence can include at least about 10%, 15%, 20%, 25%, 30%, 35%, 40%, 45%, 50%, 55%, 60%, 65%, 70%, 75%, 80%, 85%, 90%, 95%, or 99% of an organism's genome. The portion can constitute a predefined region or portion, whether contiguous or non-contiguous, of an organism's genome, for example, as obtained from a targeted sequencing technique. Alternatively or additionally, the portion can constitute one or more random regions or portions of an organism's genome, for example, as obtained from a whole genome sequencing technique.

It will be appreciated that the above ranges and minimum nucleotide lengths include all integers incorporated within the range or all integers above the specified minimum length.

In preferred embodiments, the data is analyzed by comparing the accumulating nucleotide sequence data to reference nucleotide sequences. Sequences can be compared utilizing a variety of methods. Examples of methods include utilizing a heuristic algorithm, such as a Basic Local Alignment Search Tool (BLAST) algorithm, a BLAST-like Alignment Tool (BLAT) algorithm, or a FASTA algorithm. Examples of sequence analysis software that can be used with some of the methods and systems described herein include the GCG suite of programs (Wisconsin Package Version 9.0, Genetics Computer Group (GCG), Madison, Wis.), BLASTP, BLASTN, and BLASTX (Altschul et al., J. Mol. Biol. 215:403-410 (1990); BLAT (Kent, W James (2002). “BLAT-the BLAST-like alignment tool.” Genome research 12 (4): 656-64); DNASTAR (DNASTAR, Inc. 1228 S. Park St. Madison, Wis. 53715 USA); and the FASTA program incorporating the Smith-Waterman algorithm (W. R. Pearson, Comput. Methods Genome Res., [Proc. Int. Symp.] (1994), Meeting Date 1992, 111-20. Editor(s): Suhai, Sandor. Publisher: Plenum, New York, N.Y.).

Some methods and systems described herein include databases. Databases can be used in comparing the accumulating nucleotide sequence data of the target nucleic acid with a population of database sequences. Databases can contain a population of reference sequences. The population can include a variety of types of reference sequences, for example, nucleotide sequences, polypeptide sequences, or mixtures thereof.

Although many of the analyses of the accumulating nucleotide sequence data of the target nucleic acid are described in connection with database sequences, it will be appreciated that it is not necessary to compare the accumulating nucleotide sequence data to a population of sequences in a database. In some embodiments, the accumulating nucleotide sequence can be compared to one or more references sequences obtained from any source. For example, the accumulating nucleotide sequence can be compared to one or more sequences generated by sequencing nucleic acids from reference organism either prior to or in parallel with generating the accumulating nucleotide sequence data.

In some embodiments, a population of reference sequences can be indexed. In preferred embodiments, a database can be pre-indexed for use with the methods and systems described herein. Indexing can improve the efficiency of accessing the sequences and/or attributes associated with such sequences in a database. An index can be created from a population of database sequences using one or more characteristics of each sequence. Such characteristics can be intrinsic or extrinsic to a database sequence. Intrinsic characteristics can include the primary structure of a sequence, and secondary structure of a sequence. The secondary structure of a polypeptide sequence or a nucleic acid sequence can be determined by methods well known in the art, such as methods using predictive algorithms. Extrinsic characteristics can include a variety of traits, for example, the source of a sequence, and the function of a sequence.

In one embodiment, a reference sequence can be indexed by particular characteristics using a hierarchical association between other reference sequences. A hierarchical association between reference sequences can be created for any characteristic of the reference sequences. For example, the primary structure of a reference sequence can be used to group a reference sequence according to sequence identity with other reference sequences into at least subgroups, groups, and supergroups.

In a preferred embodiment, a population of database sequences can be indexed according to the source of reference sequences using a hierarchical association between other reference sequences. In one embodiment, the source of a sequence can be characterized using phylogenetic traits that include the kingdom, phylum, class, order, family, genus, species, subspecies, and strain of an organism in which the sequence can be found.

The identity of the source of a target nucleic acid can be identified, or otherwise characterized, by one or a plurality of traits and such traits will vary with the application of the methods and systems described herein. In one embodiment, the source of a sequence can be identified by comparing the accumulating nucleotide sequencing data to reference sequences grouped by a hierarchal association. Exemplary hierarchal grouping can be made using phylogenetic traits that include, but are not limited to, the kingdom, phylum, class, order, family, genus, species, subspecies, and/or strain of an organism. In such embodiments, the identity of the source of a target nucleic acid can be identified by an association with any level of the hierarchal association. In other embodiments, a hierarchal association need not be used. In such embodiments, identification of the target nucleic acid can be made by comparing the sequence to one or more reference sequences that are ungrouped or placed in non-hierarchal groups.

In some embodiments described herein, specific classifications within a particular phylogeny for the accumulating sequencing data of a target nucleic acid are made using a particular gene as the target nucleic acid. In embodiments where target nucleic acid are obtained from a metagenomic sample, the accumulating sequence data from the target nucleic acids can be analyzed and be used to construct a weighted phylogenetic tree. In more embodiments, the accumulating sequence data from the target nucleic acids can be used to determine a specific location of the accumulating sequence data within the phylogeny that includes all potential organisms, for an example, see the methods for placing a sequence within a phylogeny described in Sundquist et al., BMC. Microbiol. (2007) 7:108, incorporated by reference for the methodology section.

In some embodiments, target nucleic acids can be highly conserved between groups of organisms but still retain some regions of variation. A variable region within a particular gene can be more informative to determine the source of a target nucleic acid, than a region that is similar between different groups of organisms. In preferred embodiments, a variable region may be used to distinguish accumulating sequencing data of a target nucleic acid between different organisms, for example, between phyla, classes, orders, families, genera, or species. In one exemplary embodiment, bacterial 16S rDNA can be used are the target nucleic acid. This particular sequence is especially useful in the analysis of metagenomic samples (Sundquist et al.,

Bacterial flora-typing with targeted, chip-based pyrosequencing, BMC. Microbiol. (2007) 7:108, incorporated by reference in its entirety).

In some embodiments, the accumulating nucleotide sequence data of a target nucleic acid can be compared to a population of reference nucleotide sequences to identify a subpopulation of reference nucleotide sequences. Such a subpopulation can match particular parameters with the accumulating nucleotide sequence of the target nucleic acid at a specified threshold. One or more parameters can be used to create a subpopulation of reference sequence nucleotides. In some embodiments, a specified threshold and parameters can be user-defined.

Parameters can include any intrinsic or extrinsic characteristic of the reference nucleotide sequences, or accumulating nucleotide sequence data of the target nucleic acid. Parameters can be inclusive and exclusive. In a preferred embodiment, a parameter used to determine a subpopulation of a population of reference nucleotide sequences can be nucleotide sequence identity. In such embodiments, a subpopulation of nucleotide sequences can have a percent sequence identity above a particular threshold with the accumulating nucleotide sequence data of a target nucleic acid. Percent sequence identity can be a relationship between two or more nucleotide sequences, as determined by comparing the sequences. In some embodiments, identity of sequences can be the degree of sequence relatedness as determined by the match between strings of such sequences. Sequence identity can be readily calculated by known methods, including but not limited to those described herein and in: Computational Molecular Biology (Lesk, A. M., ed.) Oxford University Press, New York (1988); Biocomputing: Informatics and Genome Projects (Smith, D. W., ed.) Academic Press, New York (1993); Computer Analysis of Sequence Data, Part I (Griffin, A. M., and Griffin, H. G., eds.) Humana Press, New Jersey (1994); Sequence Analysis in Molecular Biology (von Heinje, G., ed.) Academic Press (1987); and Sequence Analysis Primer (Gribskov, M. and Devereux, J., eds.) Stockton Press, NY (1991), the disclosures of which are incorporated herein by reference in their entireties).

In some embodiments, a subpopulation of reference nucleotide sequences can be examined to determine whether the subpopulation can permit sufficient identification of the source of a target nucleic acid. In one exemplary embodiment, a determination can be made by examining whether a particular percentage of the subpopulation of reference nucleotide sequences has at least one specified common association. For example, a subpopulation may permit sufficient identification of a source of a target nucleic acid where more than a particular percentage of the subpopulation of reference nucleotide sequences are of the same genus, species, or subspecies.

The particular percentage used in such embodiments can be selected by a user, and can vary with the application of methods and systems described herein. In some embodiments, the particular percentage of a subpopulation with at least one common association to permit sufficient identification of the source of a target nucleic acid can be at least 50%, at least 60%, at least 70%, at least 80%, at least 90%, at least 95%, at least 97%, and at least 99%. In preferred embodiments, 100% of members of a subpopulation of reference nucleotide sequences can have a common association to permit sufficient identification of the source of a target nucleic acid.

The common association between a subpopulation of reference nucleotide sequences may be a particular characteristic used to index the reference nucleotide sequences. For example, a common association can be the kingdom, phylum, class, order, family, genus, species, subspecies, or strain of an organism in which a particular sequence of the subpopulation of database nucleotide sequence can be found. In preferred embodiments, the common association used to determine whether a subpopulation permits sufficient identification of the source of a target nucleic acid can be selected by a user.

In one exemplary embodiment, a subpopulation of reference nucleotide sequences may permit identification of the source of a target nucleic acid where a particular percentage of a subpopulation has the common association of a class of an organism. In another exemplary embodiment, a subpopulation of reference nucleotide sequences may permit identification of the source of a target nucleic acid where a particular percentage of a subpopulation has the common association of a family of an organism. In another exemplary embodiment, a subpopulation of reference nucleotide sequences may permit identification of the source of a target nucleic acid where a particular percentage of a subpopulation has the common association of a genus of an organism. In another exemplary embodiment, a subpopulation of reference nucleotide sequences may permit identification of the source of a target nucleic acid where a particular percentage of a subpopulation has the common association of a species of an organism. In another exemplary embodiment, a subpopulation of reference nucleotide sequences may permit identification of the source of a target nucleic acid where a particular percentage of a subpopulation has the common association of a strain of an organism.

In preferred embodiments, where a subpopulation does not permit identification of the source of a target nucleic acid, sequencing of the target nucleic acid can continue. In such embodiments, analysis of the accumulating sequencing data can also continue.

In more preferred embodiments, where a subpopulation permits identification of the source of a target nucleic acid, sequencing of the target nucleic acid can be terminated. In such embodiments, termination of sequencing can be prior to the complete sequencing of the target nucleic acid or completion of a sequencing run. In further embodiments, termination of sequencing can be prior to the accumulating sequencing data becoming too ambiguous for analysis.

Systems Analysis of Accumulating Sequencing Data

Some embodiments described herein include systems for the analysis of accumulating nucleotide sequencing data. In preferred embodiments, systems include the analysis of sequence data for identifying the source of a target nucleic acid. Such systems can include a computer, a nucleic acid sequencer, a first program module, and a second program module. It will also be appreciated that the systems described herein can be applied to more polymer sequences, such as polypeptide sequences. Polypeptide sequences are well known, and methods to compare and analyze polypeptide sequences are well known.

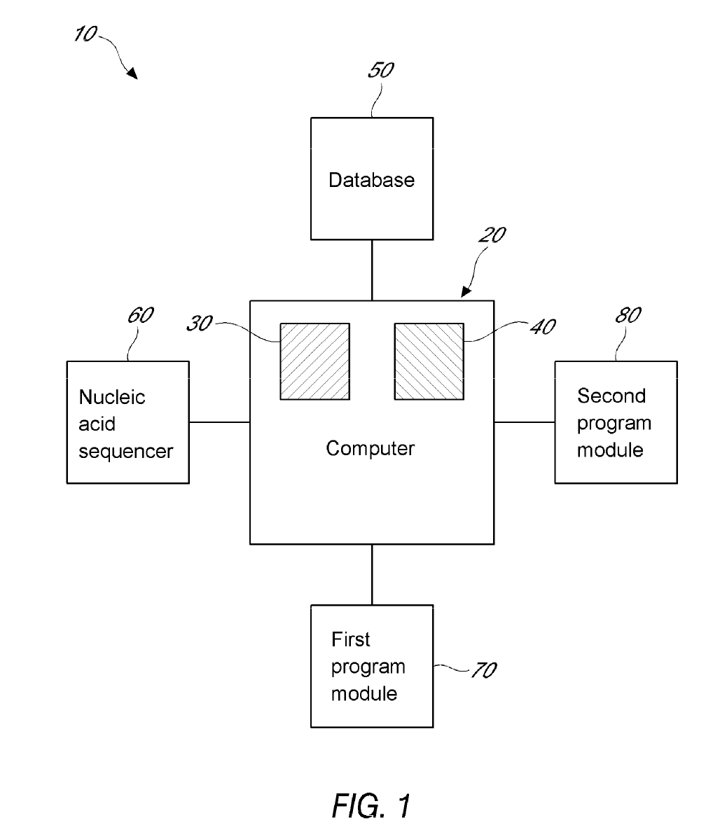

Referring to FIG. 1, some systems (10) for identifying the source of a target nucleic acid can include a computer (20) containing a memory (30) and a processor (40).

The computer (20) can be interfaced with a database (50) containing a population of reference nucleotide sequences from specified organisms. The database (50) can be remote, or can be local to the computer (20).

In some embodiments, the reference nucleotide sequences within the population of reference nucleotide sequences can be indexed. The reference nucleotide sequences can be indexed in a database according to any intrinsic and extrinsic trait of the reference nucleotide sequences. For example, reference nucleotide sequences can be indexed in a database by association with a particular species, or a particular subspecies of a specified organism. In more exemplary embodiments, reference nucleotide sequences can be indexed in a database by association with one or more groups of organisms. In further exemplary embodiments, the reference nucleotide sequences within the population of reference nucleotide sequences can be indexed in a database by a hierarchical association with a plurality of groups of organisms. In some such embodiments, the plurality of groups of organisms can be phylogenetically related.

The computer (20) can be interfaced with a nucleic acid sequencer (60). It will be appreciated that in some systems the nucleic acid sequencer can be replaced and/or include other types of sequencer , such as a polypeptide sequencer, a protein sequencer, etc. The nucleic acid sequencer (60) can be configured to perform a sequencing process to determine the nucleotide sequence of a target nucleic acid or a fragment thereof. The sequencing process can generate in the memory (30), a nucleotide sequence of at least a portion of the target nucleic acid. In some embodiments, the sequencer (60) can be under the control of the computer (20). In other embodiments, the sequencer (60) may be independently controlled. In more embodiments, the sequencing process can be an automated sequencing process. The sequencing process can include a variety of processes, for example, array-based sequencing, sequencing by hybridization, sequencing by synthesis, sequencing by ligation, any of the various protein sequencing techniques discussed, etc..

In some embodiments, the target nucleic acid can contain at least a portion of a nucleic acid encoding RuBisCo, NifH, sulfite reductase, a mitochondrial nucleic acid or 16S rRNA. In some embodiments, the mitochondrial nucleic acid comprises cytochrome c oxidase subunit I. In some embodiments, the target nucleic acid can be obtained from a metagenomic sample.

The computer (20) can be interfaced with a first program module (70). In some embodiments, the first program module (70) can be processed by the computer (20) or elsewhere if desired.

In some embodiments, the database can be replaced a second nucleic acid sequencer generating data from a reference sample comprising nucleic acids from one or more reference organisms. In some embodiments, the nucleic acid sequencer can be nucleic acid sequencer (60), wherein a first portion of the sequence information generated is that obtained from the reference sample and a second portion of the sequence information generated is that obtained from the sample comprising the target nucleic acid.

The first program module (70) can be configured to compare the nucleotide sequence of the at least a portion of the target nucleic acid to the population of reference nucleotide sequences. The comparison can identify a subpopulation of reference nucleotide sequences that match the nucleotide sequence of the at least a portion of the target nucleic acid at a specified threshold prior to the termination of said sequencing process. In some embodiments, the specified threshold can be a user specified threshold. In more embodiments, the specified threshold can be calculated based on one or more parameters.

In some embodiments, the first program module (70) can be configured to compare the nucleotide sequence of the at least a portion of the target nucleic acid or fragment thereof to the population of reference nucleotide sequences using a heuristic algorithm, for example, a BLAST algorithm, or a FASTA algorithm.

The computer (20) can be interfaced with a second program module (80). The second program module (80) can be configured to determine whether the subpopulation of reference nucleotide sequences permits sufficient identification of the source of the target nucleic acid. The second program module (80) can be further configured to provide an instruction to continue the sequencing process if the subpopulation of reference nucleotide sequences does not permit sufficient identification of the source of the target nucleic acid. In even more embodiments, the second program module (80) can be further configured to provide an instruction to terminate the sequencing process if the subpopulation of reference nucleotide sequences permits sufficient identification of the source of the target nucleic acid. In some such embodiments, the instruction to terminate the sequencing process is provided subsequent to the sufficient identification of the source of the target nucleic acid but prior to completely sequencing the target nucleic acid or completion of the sequencing run.

As discussed above, it will be appreciated, that first and second program modules can be the same program module or that the functions of the first and second program modules can be divided among three or more program modules. Additionally, it will be appreciated that the program any or all of the program modules can be processed by the computer (20) or elsewhere if desired.

While reference is made to a computer (20), such disclosure can be equally applicable to any processing circuit (whether unitary, formed from multiple components, and/or distributed across a network such as an intranet or Internet) configured (e.g. by programming instructions and/or the arrangement of dedicated hardware) to perform one or more of the functions of computer (20), program module (70), program module (80), and/or database (50) discussed above.

The processing circuit may include one or more of a microprocessor, image processing circuit, display driver, NVM controller, audio driver (e.g. D/A converter, A/D converter, an audio coder and/or decoder (codec), amplifier, etc.), and other processing circuits. The processing circuit can include various types of processing circuitry, digital and/or analog, and may include one or more of a microprocessor, microcontroller, application-specific integrated circuit (ASIC), field programmable gate array (FPGA), or other circuitry configured to perform various input/output, control, analysis, and other functions. In various embodiments, the processing circuit may include a central processing unit (CPU) using any suitable processor or logic device, such as a as a general purpose processor. The processing circuit may include, or be implemented as, a chip multiprocessor (CMP), dedicated processor, embedded processor, media processor, input/output (I/O) processor, co-processor, a microprocessor such as a complex instruction set computer (CISC) microprocessor, a reduced instruction set computing (RISC) microprocessor, and/or a very long instruction word (VLIW) microprocessor, a processor implementing a combination of instruction sets, a controller, a microcontroller, an application specific integrated circuit (ASIC), a field programmable gate array (FPGA), a programmable logic device (PLD), or other processing device in accordance with the described embodiments.

A processing circuit may be configured to digitize data, to filter data, to analyze data, to combine data, to output command signals, and/or to process data in some other manner. The processing circuit may be configured to perform digital-to-analog conversion (DAC), analog-to-digital conversion (ADC), modulation, demodulation, encoding, decoding, encryption, decryption, etc. The processing circuit (e.g. microprocessor) may be configured to execute various software programs such as application programs and system programs to provide computing and processing operations.

The processing circuit may also include a memory that stores data. The processing circuit may include only one of a type of component (e.g. one microprocessor), or may contain multiple components of that type (e.g. multiple microprocessors). The processing circuit could be composed of a plurality of separate circuits and discrete circuit elements. In some embodiments, the processing circuit can essentially comprise solid state electronic components such as a microprocessor (e.g. microcontroller). The processing circuit may be mounted on a single board in a single location or may be spread throughout multiple locations which cooperate to act as the processing circuit. The components of a processing circuit may be located within a single housing, or may be provided in multiple housing which are coupled in a manner that allows the claimed functions of the processing circuit to be performed. In some embodiments, a processing circuit may be located in a single location and/or all the components of a claimed processing circuit will be closely connected.

Components shown as part of a single processing circuit in the figure may be parts of separate processing circuits in various embodiments covered by the claims unless limited by the claim to a single processing circuit. In some embodiments, at least a portion (e.g. all or some) of the processing circuit may be part of (e.g. in a common housing with and/or provide some or all of the control and/or operation of) the biological material analysis device (e.g. sequencer 60).

Some embodiments of the systems described herein also include one or more additional program modules that analyze raw sequencing signal data, for example, fluorescent signal intensity. Such modules permit the identification of nucleotide bases produced by each round of sequencing while the sequencing data is accumulating. Such a program module can comprise one or more base calling programs and one or more error checking or validation programs. In some embodiments, the one or more base calling programs utilize the sequencing signal data as it is generated to identify the nucleotides present at one or more sequence positions of the accumulating nucleotide sequence. In other embodiments, the sequencing signal data is pre-processed or transformed prior to it's analysis. In such embodiments, the sequencing signal data is analyzed prior to completely sequencing the target nucleic acid or prior to completing the sequencing run.

In some embodiments, the systems described herein can be a handheld device for use at point of patient care.

Polypeptide Sequencing

It will be appreciated that although the proceeding discussion includes applications to nucleotide sequences, particular embodiments may also be applied to to polypeptide sequences. For example, some embodiments can include sequencing polypeptides. Some embodiments can further comprise comparing accumulating sequence data to a pre-indexed database of polypeptide sequences. Sequencing can continue until a particular characteristic of the polypeptide is determined. Examples of particular characteristics of a polypeptide sequence can include the source of a polypeptide, for example, an organism and/or virus, the family of proteins that a polypeptide may be associated with, biochemical pathways that a polypeptide may be associated with, primary, secondary and/or tertiary structural motifs that may associate a polypeptide with other polypeptide sequences.

Methods to sequence a polypeptide are well known and include methods of mass spectrometry, and Edman degradation. In one example of a method that uses mass spectrometry to sequence polypeptides, a protein is digested by an endoprotease, and the resulting solution is passed through a high pressure liquid chromatography column. At the end of this column, the solution is sprayed out of a narrow nozzle charged to a high positive potential into the mass spectrometer. The charge on the droplets causes them to fragment until only single ions remain. The peptides are then fragmented and the mass-charge ratios of the fragments measured. The mass spectrum of the fragments is analyzed and compared against a database of previously sequenced proteins to determine the sequence of the fragments.

### EXAMPLES

### Example 1

### Identification of Bacterial Pathogens at Point of Care

An epithelial sample is obtained from a patient and DNA extraction is performed on the sample. Target-specific PCR is performed on the extracted DNA using universal primers directed to 16S rDNA. DNA sequencing of the amplified DNA is initiated. As the DNA sequencing data accumulates, each accumulating nucleotide sequence is analyzed by comparing the accumulating sequence with a pre-indexed database of bacterial 16S rRNA sequences using a BLAST algorithm. The database is pre-indexed according to bacterial phylogeny. Each accumulating sequence is further analyzed to a desired classification level within the bacterial phylogeny of the database sequences.

DNA sequencing and analysis of the accumulating sequence data continues until the genus of one or more bacteria present in the sample is determined. Alternatively, sequencing can continue until the species of one or more bacteria present in the sample is determined. As another alternative, sequencing may continue to any desired level of identification once a pathogenic bacterium or suspected pathogenic bacterium is identified.

### Example 2

### Identification of Viral Pathogens in Sewage Effluent

A sample of sewage effluent is obtained and DNA extraction is performed on the sample. Array-based DNA sequencing of the extracted DNA is initiated. As the DNA sequencing data accumulates, each accumulating nucleotide sequence is analyzed by comparing each accumulating sequence to a pre-indexed database containing bacterial and viral sequences using a FASTA algorithm. The database is pre-indexed according to bacterial and viral phylogeny. Each accumulating sequence is further analyzed to a desired classification level within the bacterial and viral phylogeny of the database sequences.

DNA sequencing and analysis processes of accumulating sequence data for particular accumulating nucleotide sequences continue until a group of pathogenic viruses for an accumulating sequence is determined, until a sub-group of pathogenic viruses for an accumulating sequence is determined, or until a specific pathogenic virus for an accumulating sequence is determined.

Alternatively DNA sequencing and analysis processes are terminated where only non-viral bacterial sequences for accumulating sequences are determined, where only non-viral Escherichia sequences for accumulating sequences are determined, or where only non-viral Escherichia coli sequences for accumulating sequences are determined.

### Example 3

### Identification of Polymorphic Markers in Human Tissue Samples

A human tissue sample is obtained, such as from blood or a mouth swab, and DNA is extracted from the sample. The genome is amplified on the surface of a flow cell and array-based sequencing is initiated on the extracted DNA as described, for example, in Bentley et al. Nature 456:53-59 (2008). As the DNA sequencing data accumulates, each accumulating nucleotide sequence is analyzed by comparing each accumulating sequence to a population of reference nucleotide sequences. The population of reference sequences comprises polymorphic markers including disease alleles and equivalent non-disease alleles.

DNA sequencing and analysis processes of accumulating sequence data for particular polymorphic markers continue until the presence of at least one disease allele or the equivalent non-disease allele is determined.

### Example 4

### Identification of Food Source and Pathogens

A sample of a food product is obtained. DNA sequencing is initiated on the food sample. As sequencing data accumulates, the data is compared to a pre-indexed database of nucleic acid sequences. Characteristics according to any one or more of the following parameters according to the origin of a sequence can be determined: kingdom, phylum, class, order, family, genus, and species. Sequencing data can accumulate until a particular characteristic is obtained, such as the genus of an organism for the origin of a sequence characteristic of the source of the food material. The organism can be a component of the food material and/or a pathogenic organism present on or in the food material.

### Example 5

### Identification of Pathogens in an Air Supply

A sample of air is obtained. Organic material in the air is concentrated and sequence information is obtained from the organic material. As sequence information accumulates, the sequence data is compared to a pre-indexed database of sequences containing sequences of pathogenic organisms. Sequence information can accumulate until a characteristic of a sequence is determined, such as the particular phylum, class, order, family, genus, and species relating to the source of a sequence. For example, sequence information can accumulate until the genus of a particular pathogenic organism is determined.

The above description discloses several methods and systems of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention.

All references cited herein including, but not limited to, published and unpublished applications, patents, and literature references, are incorporated herein by reference in their entirety and are hereby made a part of this specification. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

1-49. (canceled)

50. A method for identifying the source of a target nucleic acid, said method comprising the steps of:
(a) initiating a sequencing process to determine the nucleotide sequence of the target nucleic acid or a fragment thereof, thereby generating a nucleotide sequence of at least a portion of the target nucleic acid;
(b) prior to terminating the sequencing process, comparing the nucleotide sequence of the at least a portion of the target nucleic acid to the population of reference nucleotide sequences from at least one specified organism so as to identify a subpopulation of reference nucleotide sequences that match the nucleotide sequence of the at least a portion of the target nucleic acid at a specified threshold; and
(c) determining whether the subpopulation of reference nucleotide sequences permit sufficient identification of the source of the target nucleic acid, wherein the sequencing process is continued and steps (b) and (c) are repeated if the subpopulation of reference nucleotide sequences does not permit sufficient identification of the source of the target nucleic acid, and wherein the sequencing process is terminated if the subpopulation of reference nucleotide sequences permits sufficient identification of the source of the target nucleic acid.

51. The method of claim 50, wherein said sequencing process is terminated subsequent to the sufficient identification of the source of the target nucleic acid but prior to completely sequencing the target nucleic acid.

52. The method of claim 50, wherein the sequencing process is performed on a single target nucleic acid or simultaneously on a plurality of target nucleic acids.

53. The method of claim 50, wherein reference nucleotide sequences within the population of reference nucleotide sequences are indexed in a database by an association selected from an association with a particular species of the specified organism, an association with a particular subspecies of the specified organism, association with one or more groups of organisms, a hierarchical association with a plurality of groups of organisms, and a hierarchical association with a plurality of groups of organisms, wherein the plurality of groups of organisms is phylogenetically related.

54. The method of claim 50, wherein said sequencing process comprises a process selected from array-based sequencing, sequencing by hybridization, sequencing by synthesis and sequencing by ligation.

55. The method of claim 50, wherein the subpopulation of reference nucleotide sequences permits sufficient identification of the source of the target nucleic acid if at least a specified percentage of the reference nucleotide sequences within the subpopulation are selected from the group consisting of the same genus of organism, the same species of organism and the same subspecies of organism.

56. A system for identifying the source of a target nucleic acid, said system comprising:
a computer comprising a memory, said computer interfaced with a database comprising a population of reference nucleotide sequences from at least one specified organism;
a nucleic acid sequencer configured to perform a sequencing process to determine the nucleotide sequence of a target nucleic acid or a fragment thereof, thereby generating in said memory a nucleotide sequence of at least a portion of the target nucleic acid;
a first program module interfaced with said computer, wherein the first program module is configured to compare the nucleotide sequence of the at least a portion of the target nucleic acid to the population of reference nucleotide sequences so as to identify a subpopulation of reference nucleotide sequences that match the nucleotide sequence of the at least a portion of the target nucleic acid at a specified threshold prior to the termination of said sequencing process; and
a second program module interfaced with said computer, wherein the second program module is configured to determine whether the subpopulation of reference nucleotide sequences permits sufficient identification of the source of the target nucleic acid.

57. The system of claim 56, wherein the second program module is further configured to provide an instruction to continue the sequencing process if the subpopulation of reference nucleotide sequences does not permit sufficient identification of the source of the target nucleic acid.

58. The system of claim 56, wherein the second program module is further configured to provide an instruction to terminate the sequencing process if the subpopulation of reference nucleotide sequences permits sufficient identification of the source of the target nucleic acid.

59. The system of claim 58, wherein the instruction to terminate the sequencing process is set to be provided subsequent to the sufficient identification of the source of the target nucleic acid but prior to completely sequencing the target nucleic acid.

60. The system of claim 56, wherein said first and second program modules are the same program module.

61. The system of claim 56, wherein the program module processed by said computer is selected from the first program module, the second program module and a combination of the first and second program modules.

62. The system of claim 56, wherein said database is selected from the group consisting of a remote database, a local database, and a combination of a remote and local database.

63. The system of claim 56, wherein said nucleic acid sequencer is under control of said computer.

64. The system of claim 56, wherein said sequencing process is an automated sequencing process.

65. The system of claim 56, wherein reference nucleotide sequences within the population of reference nucleotide sequences are indexed in the database by an association selected from the group consisting of an association with a particular species of the specified organism, an association with a particular subspecies of the specified organism, association with one or more groups of organisms, a hierarchical association with a plurality of groups of organisms, and a hierarchical association with a plurality of groups of organisms, wherein the plurality of groups of organisms is phylogenetically related.

66. The system of claim 56, wherein said target nucleic acid comprises at least a portion of a nucleic acid encoding RuBisCo, NifH, sulfite reductase, a mitochondrial nucleic acid or 16S rRNA.

67. The system of claim 56, wherein said sequencing process comprises a process selected from the group consisting of array-based sequencing, sequencing by hybridization, sequencing by synthesis and sequencing by ligation.

68. The system of claim 56, wherein said first program module is configured to compare the nucleotide sequence of the at least a portion of the target nucleic acid or fragment thereof to the population of reference nucleotide sequences using a heuristic algorithm.

69. The system of claim 56, wherein said specified threshold is selected from a user specified threshold or a threshold calculated based on one or more parameters.
